(19) United States
(12) Patent Application Publication
(10) Pub. No.: US 2008/0288908 A1
(43) Pub. Date: Nov. 20, 2008

(54) SIMULTANEOUS DESIGN OF INTEGRATED CIRCUIT AND PRINTED CIRCUIT BOARD

(75) Inventors: Martin Hart, Irvine, CA (US); Joseph C. Fjelstad, Maple Valley, WA (US)

Correspondence Address: KNOBBE MARTENS OLSON & BEAR LLP, 2040 MAIN STREET, FOURTEENTH FLOOR, IRVINE, CA, 92614, US

(73) Assignee: Mirror Semiconductor, Inc., Irvine, CA (US)

(21) Appl. No.: 12/121,440

(22) Filed: May 15, 2008

Related U.S. Application Data
(60) Provisional application No. 60/938,097, filed on May 15, 2007.

(51) Int. Cl. G06F 17/50

(52) U.S. Cl. 716/15

(57) ABSTRACT

A printed circuit board (PCB) circuit assembly is designed utilizing software to create the best performing “total design” by selecting component layout locations, optimizing the circuit routing of the PCB copper (or other metallic) traces, and simultaneously optimizing the interconnections between a “standard” die inside an integrated circuit (IC) package and an interposer substrate of the IC package.

### CROSS-REFERENCE TO RELATED APPLICATIONS

The present application is based on and claims priority to U.S. Provisional Application No. 60/938,097, filed May 15, 2007, the entire contents of which are incorporated by reference and should be considered a part of this specification.

### BACKGROUND OF THE INVENTION

1. Field of the Invention

The present invention relates to printed circuit boards (PCB) and integrated circuit (IC) packaging technology for semiconductor devices, and more particularly to the field of electronic interconnection structures of ICs, and/or IC packages, and PCBs and the simultaneous design of the same.

2. Description of the Related Art

In the fields of electronic and electrical devices, most manufactured products comprise a variety of sub-components that require interconnection. At the present, it is estimated that more than 90% of PCB board level designs use standard “commercial off-the-shelf” (COTS) components. These components include discrete devices such as resistors, capacitors, diodes and the like, along with integrated circuits (ICs) that are available from many different semiconductor providers. With respect to ICs, there is often an agreement among suppliers to provide competitive products that are “pin for pin” compatible and these ICs are thus considered “standard” components.

Conventional design of electronic assemblies involves engineers and circuit designers developing circuit schematics around such “standard” off-the-shelf ICs. For example, engineers and circuit designers may use computer assisted design (CAD) and electronic design automation (EDA) software to layout and route interconnections on the printed circuit board. An auto-routing feature of the CAD and EDA software, using defined design rules based on an “expert system”, can also be used to generate the initial layout location of components on the PCB and the suggested interconnection circuit routing. However, due to a number of different, often subtle factors, the initial design generated by the CAD and EDA software frequently is modified based on the designer's knowledge and experience to improve the design.

Once the design is completed, digital data files can be obtained from the CAD and EDA software that can be used in the fabrication of the PCB. The PCB is subsequently assembled by populating its surface with the desired components (e.g., components defined on the Bill of Materials (BOM) that correlates to the circuit schematic).

While application specific integrated circuits (ASICs) can be used, they are expensive and thus the current state of the art for designing most PCB circuit assemblies is constrained by the designer having to use only “standard” off-the-shelf components along with CAD (EDA) software, which may be modified by the designer's knowledge and experience to give special attention to the best possible path when connecting the pins of one component to those of another. Though simple PCB circuit assembly designs that comprise a small number of components and a limited number of connections between pins can be accomplished using just one or two metal layers, a multi-layer PCB circuit assembly is often required as the number of components and the number of pins on those components rise, so as to avoid a short circuit when circuit routes cross paths but also adding to cost.

The current state of the art purposely constrains the design choices to those that are standard because the design process of a PC board circuit assembly is generally broken into discrete areas of design. That is, the design of “standard” IC “die” (e.g. silicon chip) is one design operation. The design of the IC “package” follows the design of the IC “die”, providing pin assignments that may, and often do, become standardized. These standard IC packages then establish the basis for the next design level (i.e., PCB design). Decisions relative to the placement of “standard” IC packages are often made based on a series of trade offs between electrical, thermal and mechanical needs. Once component and termination locations are established and the circuit schematic is loaded, CAD (EDA) auto routing of the circuit board can begin. Because, such designs begin with standard IC packages, the results are inevitably less than “optimum”. By “optimum”, it is meant that the circuit has certain desirable attributes and may be, for example, physically smaller in size, contain fewer inner layers, perform faster or be less costly to manufacture. However, the criteria for defining an “optimum” circuit is not limited to those listed above and may include other desirable attributes.

In summary, in the current state of the art, the design of PCB circuit assemblies is cumbersome, less than optimum and typically limited by the use of standard off-the-shelf components, which constricts the circuit routing configuration on the PCB. In light of the foregoing disadvantages of current circuit design, it is evident that there is both a need for improved methods for better interrelating and integrating the design, manufacturing and assembly processes used in the creation of electronic assemblies via improved IC packaging and PCB design practices.

### SUMMARY OF THE INVENTION

In view of the circumstances noted above, an aspect of at least one of the embodiments disclosed herein is to provide a PCB circuit assembly where at least one IC package and the PCB are designed simultaneously and cooperatively to achieve an optimal PCB circuit assembly design.

In accordance with one aspect of the invention, the internal wire bonding of a standard “die” inside an IC package is optimized, while simultaneously optimizing the component layout locations and routing of the circuit interconnections on the PCB.

In accordance with another aspect of the invention, a PCB circuit assembly is designed utilizing software to create the best performing “total design” by, for example: selecting component layout locations, optimizing the circuit routing of the PCB traces and simultaneously optimizing the interconnections (e.g., wire bonding) of a “standard” die inside an IC package to the external pins (or contacts) on the IC package. As such, the IC package is a “custom” IC package that, while it may contain a standard “die” and standard lead-frame or standard area array package, it is uniquely customized and defined by the interconnections (e.g., wire bonding schedule) determined by the program for connecting the standard die to the inteposer substrate of the IC package to optimize the overall circuit and electronic assembly design.

In accordance with one aspect of the present invention, a computer-implemented method is provided for designing interconnections for a printed circuit board (PCB) circuit assembly by simultaneously designing an integrated circuit (IC) package having a die chip and a printed circuit board (PCB) onto which the IC package is coupled. The method comprises accessing a routing pattern from a computer storage, said routing pattern providing the interconnection of at least two components of a desired circuit on a PCB, at least one of the components being an IC package, said routing pattern defining a preliminary circuit design. The method also comprises determining if the preliminary circuit design defined by a pattern of interconnections between a die chip and an interposer substrate of the IC package and by the routing pattern between the components on the PCB meet a pre-selected set of criteria stored in a computer readable medium. The method further comprises iterating between revising the pattern of interconnections (e.g., wire bonds) between the die chip and the interposer substrate of the IC package (or within the interposer substrate itself) and revising the routing pattern interconnecting components on the PCB until the set of pre-selected criteria are met to provide a final circuit design and outputting said final circuit design to a user. Additionally, the method comprises outputting digital data files corresponding to the final circuit design to a user, said digital data files usable to document, fabricate, test and assemble the PCB and the IC package.

In accordance with another aspect of the present invention, a method is provided for designing a printed circuit board (PCB) circuit assembly by simultaneously designing an integrated circuit (IC) package having a die and a printed circuit board (PCB) onto which the IC package is coupled. The method comprises creating a schematic of the desired circuit, selecting at least two components for said circuit, at least one of said components being an IC package having a die chip, evaluating thermal and mechanical placement restrictions for the components, and defining the input/output configuration of the IC package. The method further comprises laying out a pattern of interconnections between the die and an interposer substrate of the IC package, defining a position of each of the components on the circuit, generating a routing pattern to interconnect the components to define a preliminary circuit design and storing the routing pattern in a computer storage, determining if the preliminary circuit design defined by the pattern of interconnections of the IC package and the routing pattern of the PCB meet a pre-selected set of criteria stored in a computer-readable medium, iterating between revising the pattern of interconnections between the die and the interposer substrate of the IC package and revising the routing pattern interconnecting components on the PCB until the set of pre-selected criteria are met to provide a final circuit design and outputting said final circuit design to a user, generating digital data files corresponding to the final circuit design to document, fabricate, test and assemble the PCB and the IC package, and outputting the digital data files to at least one of a user and an IC wire bonding machine.

In accordance with yet another aspect of the present invention, a system is provided for designing a printed circuit board (PCB) circuit assembly by simultaneously designing an interconnection plan between an integrated circuit (IC) package having a die and a printed circuit board (PCB) onto which the IC package is coupled. The system comprises a computer storage that stores a routing pattern of interconnections between at least two components of a desired circuit on a PCB, at least one of the components being an IC package, the routing pattern defining a preliminary circuit design, and a computer memory that stores a pre-selected set of design criteria. The system also comprises a processor programmed to determine if the preliminary circuit design defined by the routing pattern between the components on the PCB and by a pattern of interconnections between a die chip and an interposer substrate of the IC Package meet the pre-selected set of design criteria, the processor configured to iterate between revising the pattern of interconnections between the die chip and the interposer substrate of the IC package and revising the routing pattern interconnecting components on the PCB until the set of pre-selected design criteria are met to provide a final circuit design.

In accordance with still another aspect of the present invention, a computer-readable medium is provided. The computer-readable medium has stored thereon instructions that, when executed by a computer, cause the computer to access a routing pattern of interconnections between at least two components of a desired circuit on a PCB, at least one of the components being an IC package, said routing pattern defining a preliminary circuit design, determine if the preliminary circuit design defined by a pattern of interconnections between a die chip and an interposer substrate of the IC package and by the routing pattern between the components on the PCB meet a pre-selected set of criteria, iterate between revising at least one of the pattern of interconnections between the die chip and the interposer substrate of the IC package and revising the routing pattern interconnecting components on the PCB until the set of pre-selected criteria are met to provide a final circuit design, and output said final circuit design to a user.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 7 figures.

FIG. 1 shows a schematic view of a circuit.

FIG. 2A shows a schematic view of one embodiment of an IC package.

FIG. 2B shows a schematic view of the embodiment in FIG. 2A with insulated bond wires crossing over each other.

FIGS. 3A-B shows a schematic view of another embodiment of an IC package.

FIGS. 4A-B shows a schematic view of still another embodiment of an IC package.

FIG. 5 shows a schematic view of yet another embodiment of an IC package.

FIG. 6 shows a flow chart showing one embodiment of a method for simultaneously designing an IC package and printed circuit board (PCB).

FIG. 7 shows a block diagram illustrating a computer system that can be used in connection with the method in FIG. 5.

### DETAILED DESCRIPTION OF THE PREFERRED EMBODIMENTS

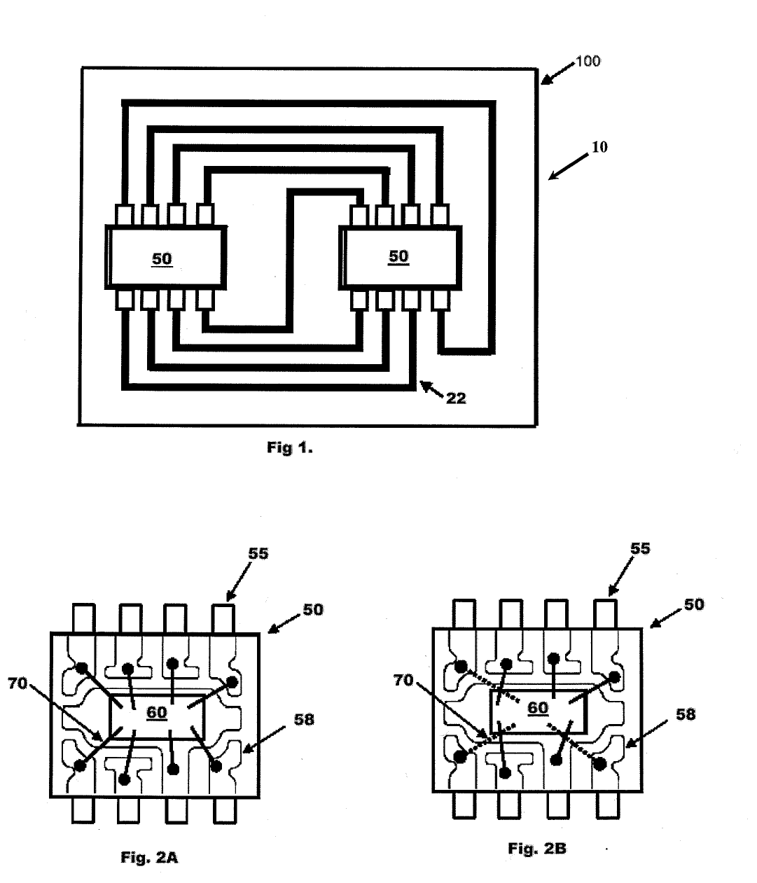

FIG. 1 schematically illustrates a printed circuit board (PCB) circuit assembly 100. The PCB circuit assembly 100 includes a PCB 10 with a variety of components mounted thereon, including at least one integrated circuit (IC) package 50. Traces 22, which can be made of copper or another suitable metallic conductor, define the circuit routing layout on the PCB 10 between the different components. Though only two IC packages 50 are shown in FIG. 1, one of ordinary skill in the art will recognize that the PCB circuit assembly can include a variety of components (e.g., resistors, capacitors, diodes), in addition to the IC packages 50, and that the number of components can vary as needed for the particular PCB circuit assembly.

FIGS. 2A-B are schematic illustrations of one embodiment of an IC package 50. In the illustrated embodiment, the IC package 50 includes an IC die 60 (e.g., silicon chip) coupled to an interposer substrate (or lead frame) 58 via a plurality of bond wires 70. The IC package 50 also includes a plurality of terminations 55 to interconnect the IC package 50 to the PCB 10. In one embodiment, the terminations 55 can be pins, leads or pads. Though the illustrated embodiment shows pins 55 on only two sides of the IC package 50, one of ordinary skill in the art will understands that the embodiments disclosed herein can also be used to design IC packages with pins (or other terminations) on more or fewer sides than shown in FIGS. 2A-B. The IC die 60 can be a standard IC die that can be provided by a number of different semiconductor providers (e.g., Intel Corporation, AMD, Inc.). The bond wires 70 can be made of any suitable metal, alloy or material known to one of ordinary skill in the art. In one embodiment, the bond wires 70 can have any suitable wire bond schedule and be made using traditional wire bonding technologies. In another embodiment, the bond wires 70 can be insulated, such as those described by Microbonds, of Markham, Ontario, Canada, allowing wires to cross over one another without concern for creating short circuits (e.g., dashed lines in FIG. 2B). Likewise, the interposer 58 can be made of any suitable substrate material known to those of ordinary skill in the art. Though the IC package 50 in FIGS. 2A-B only illustrates the IC die 60, one of ordinary skill in the art will recognize that the IC package 50 can include other components.

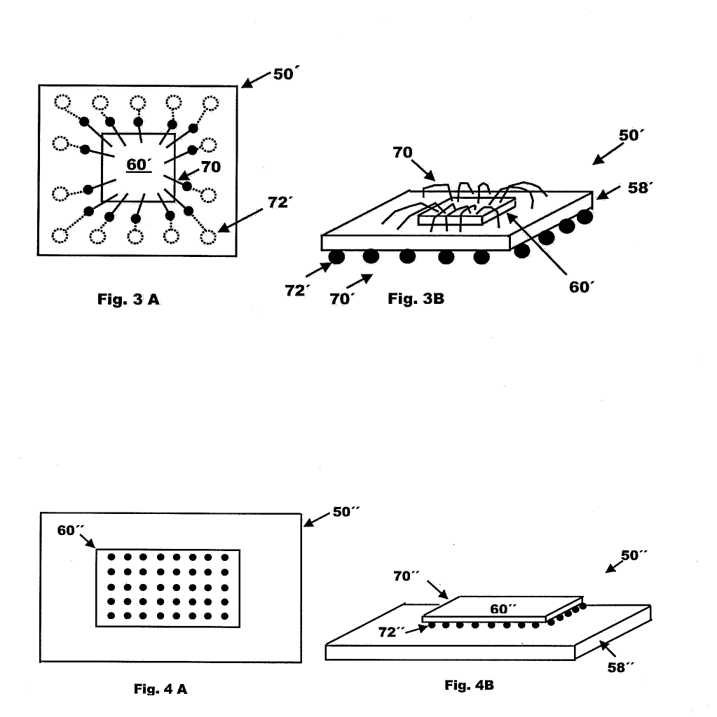

FIGS. 3A-B are schematic illustrations of another embodiment of an IC package 50′. In the illustrated embodiment, the IC package 50′ has an IC die 60′ coupled to an interposer 58′ via a plurality of bond wires 70 to a ball grid array (BGA) 70′, as commonly known to one of ordinary skill in the art. For example, the BGA 70′ can include a plurality of solder balls, solder bumps or metallic conductive pads (e.g., a land grid array) 72′ arranged in a pattern corresponding to a pattern of a plurality of, for example, copper pads (not shown) on the interposer.

FIGS. 4A-B are schematic illustrations of another embodiment of an IC package 50″. In the illustrated embodiment, the IC package 50″ has an IC die 60″ coupled to an interposer 58″ in a flip-chip manner 70″, as commonly known to one of ordinary skill in the art. For example, the IC die 60″ can include solder bumps or stud bumps 72″, and the IC die 60″ be inverted and coupled to the interposer 58″ via melting of the solder bumps or compression of the stud bumps 72″.

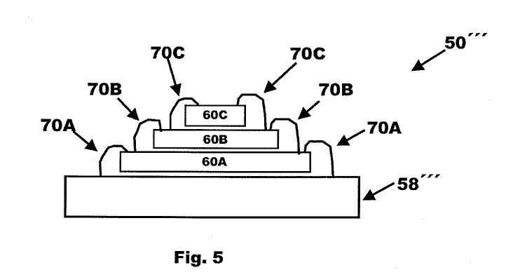

However, in another embodiment shown in FIG. 5, the IC package 50′″ has more than one IC die 60A, 60B, 60C stacked on top of one another, with at least one IC die 60A coupled to an interposer 58′″, as commonly known to one of ordinary skill in the art. While FIG. 5 only illustrates a wire bond assembly, such stacked assemblies can include mixtures of wire bonded and flip chip interconnections. Though FIGS. 2A-5 illustrate different embodiments of IC packages that may be designed using the processes described herein, one of ordinary skill in the art will recognize that the invention is not limited to these illustrated IC package embodiments, but that the design processes can be used to design any suitable IC package type.

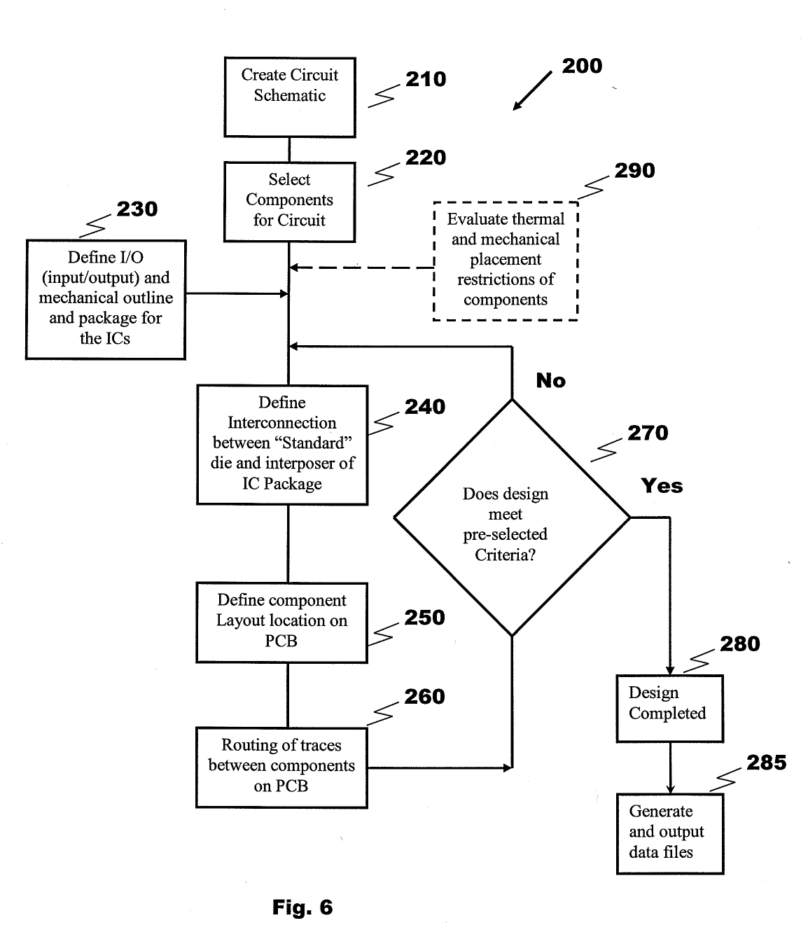

FIG. 6 is a block diagram of one embodiment of a method 200 for simultaneously designing the PCB 10 and IC package 50 to provide an optimized PCB circuit assembly 100 with at least one “custom” IC package 50. Though the following describes the simultaneous design of one custom IC package 50 and the PCB 10, one of ordinary skill in the art will recognize that the method 200 encompasses the simultaneous design of a plurality of custom IC packages 50 and the PCB 10 to which the IC packages 50 are to be coupled to provide the PCB circuit assembly 100. Additionally, the method 200 contemplates incorporating any number of components (e.g., resistors, capacitors, diodes, etc.) into the PCB circuit assembly 100, as well as the use of “standard” IC packages (as described above) along side “custom” IC packages 50.

In one embodiment, the method 200 includes the step of generating a schematic 210 of a proposed circuit. This schematic may be generated manually by a circuit designer, or can be automated using a computer program, as further described below. Components are then selected 220 to meet the requirements of the proposed circuit. Such components can include resistors, capacitors, diodes, standard ICs, etc.

Next, the input/output (I/O) configuration of the “custom” IC package 50 are defined 230. For example, the number of pins for the IC package 50 can be defined.

With continued reference to FIG. 6, the interconnections between the IC die 60 and the interposer 58 are laid out 240 to provide pathways between the IC die 60 and the terminations 55 (e.g., pins) on the IC package 50 to provide the “custom” IC package 50. In a preferred embodiment, the interconnections between the IC die 60 and the interposer 58 are bond wires 70, as described above. However, in another embodiment the interconnections between the IC die 60 and the interposer 58 are a BGA. In still another embodiment, the IC die 60 is interconnected with the interposer 58 in a flip-chip manner.

The components identified in step 220 are then laid out 250 in a first configuration on the PCB 10 and a routing pattern is generated 260 to interconnect the components, including connecting to the input/output pins of the IC package 50, to provide a PCB 10 design. The routing pattern can be generated manually or using a computer program, as further discussed below. Additionally, the routing pattern, whether manually or can be stored in a computer storage (e.g., computer memory, CD, hard drive), from which it can be accessed by a computer program as discussed below.

At this point, an evaluation 270 is made whether the “custom” IC package 50 and PCB 10 designs are optimal designs as defined by a pre-selected set of criteria. For example, the pre-selected set of criteria can include any of, or combination of, electrical parameters, mechanical parameters, thermal parameters, size parameters, weight parameters, operating speed parameters, copper trace length parameters, and parameters on the amount of materials used in the designs. For example, the pre-selected set of criteria can include thermal parameters requiring that the operating temperature of the PCB circuit assembly 100 not exceed the recommended safe operating limit. In another embodiment, the pre-selected set of criteria can include operating speed parameters requiring that the operating speed of the PCB circuit assembly 100 attain certain frequencies or timing requirements. However, such pre-selected criteria can include other parameters in addition to, or in place of, those listed above. Additionally, one of ordinary skill in the art will recognize that the quantitative ranges for the parameters in the pre-selected set of criteria can vary depending on the design objectives of the designer. In one embodiment, the pre-selected set of criteria can be input by a user into a computer and be stored in a computer-readable medium from which the criteria can be accessed by the computer program.

If a determination is made at step 270 that the IC package 50 and PCB 10 designs meet the pre-selected set of criteria so that they are optimal for the needs of the completed electronic assembly; the design process is complete 280. However, if it is determined at step 270 that at least one of the IC package 50 and PCB 10 designs or design elements does not meet the pre-selected set of criteria and is therefore not optimal, the design process returns to step 240 and the layout of the interconnections between the IC die 60 and the interposer 58 are revised to provide a revised IC package 50 design. Thereafter, the layout of the components identified in step 220 is also revised and the routing pattern generated 260 again to interconnect the components to provide a revised PCB 10 design. The revised IC package 50 and PCB 10 designs are then evaluated 270 to determine if they are optimal designs. If so, the design process stops 280. If not, the design process returns to step 240.

This iterative process continues until the pre-selected set of criteria is met and the IC package 50 and PCB 10 designs are deemed optimal and the design completed 280. Once the design is completed, the computer program can output the final circuit design (e.g., IC package 50 and PCB 10 designs) to the user. Additionally output files (e.g., digital data files, AutoCAD files, gerber files, etc.) can be generated 285 and output to a user or storage medium to document, fabricate, test and assemble the custom IC package 50 and/or PCB 10 in the optimized design. The output files can include, for example, the wire bonding schedule for the custom IC package 50 (e.g., the bond wire 70 interconnections between the IC die 60 and the interposer substrate 58). The output files corresponding to the optimized design for the IC package 50 and PCB 10 can then be used to manufacture the custom IC package 50 and/or PCB 10, which can be assembled to provide an optimal IC package circuit assembly 100.

In one embodiment, the method 200 can include an optional step 290 of evaluating other attributes, including but not limited to, thermal and mechanical placement restrictions of the selected components following step 220, as shown in FIG. 6 in dashed-line form.

In one embodiment, the method 200 disclosed above for simultaneously designing the PCB 10 and at least one “custom” IC package 50 can be performed manually by a designer. In another embodiment, as further described below, the method 200 can be performed substantially entirely by software loaded onto a computer system, which can consist of existing CAD/EDA software modified to perform the optimization steps described above. In still another embodiment, the method 200 can be performed manually at least in part, and by software at least in part. For example, the design method 200 can be performed by software but allow for a designer to interrupt the operation of the software and input design choices (e.g., layout of components, routing of interconnections between components) based on the designer's know-how and experience.

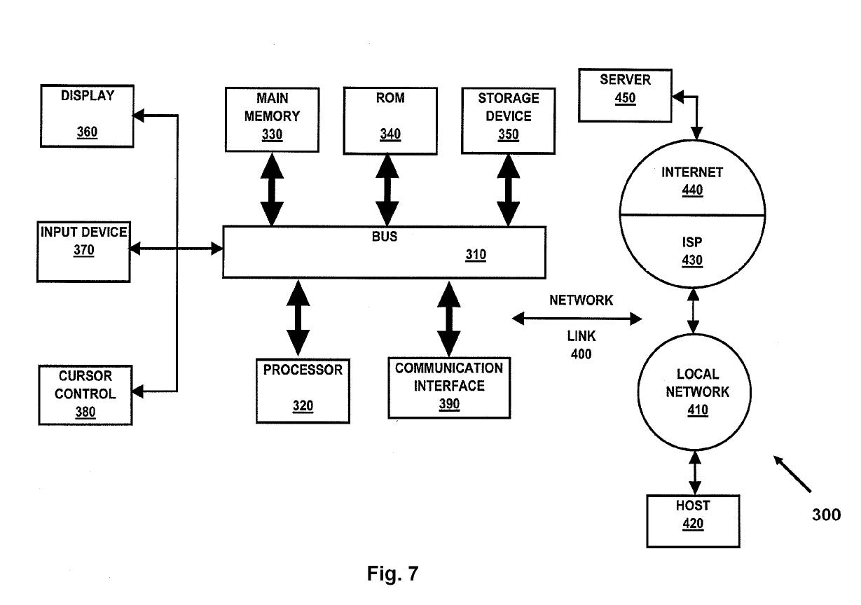

FIG. 7 is a block diagram that illustrates a computer system 300 upon which an embodiment of the invention may be implemented. The computer system 300 can include a bus 310 or other communication mechanism for communicating information, and a processor 320 coupled with the bus 310 for processing information. The computer system 300 can also include a main memory 330, such as a random access memory (RAM) or other dynamic storage device, coupled to the bus 310 for storing information and instructions to be executed by the processor 320, such as the method 200 in FIG. 6. The main memory 330 can also be used for storing temporary variable or other intermediate information during execution of instructions to be executed by the processor 320. The computer system 300 can further include a read only memory (ROM) 340 or other static storage device coupled to the bus 310 for storing static information and instructions provided for the processor 320. A storage device 350, such as a magnetic disk or optical disk, can also be provided and coupled to the bus 310 for storing information and instructions.

The computer system 300 may be coupled via the bus 310 to a display 360, such as a cathode ray tube (CRT) or flat panel display, for displaying information to a computer user, such as a circuit designer. An input device 370, including alphanumeric and other keys, can be coupled to the bus 310 for communicating information and command selections to the processor 320. Another type of user input device is cursor control 380, such as a mouse, a trackball, or cursor direction keys for communicating direction information and command selection to the processor 320 and for controlling cursor movement on the display 360. This input device typically has two degrees of freedom in two axes, a first axis (e.g., X) and a second axis (e.g., Y), that allows the device to specify position in a plane.

In one embodiment, the computer system 300 is used to simultaneously design the PCB 10 with at least one “custom” IC package 50 so that the PCB 10 and IC package 50 designs are optimal, as defined by criteria described above. According to one embodiment, the simultaneous design of the PCB 10 and at least one “custom” IC package 50 is provided by the computer system 300 in response to the processor 320 executing one or more sequences of one or more instructions contained in the main memory 330. Such instructions may be read into the main memory 330 from another computer-readable medium, such as the storage device 350. Execution of the sequences of instructions contained in the main memory 330 causes the processor 320 to perform the process steps described herein (e.g., the steps of the design method 200). One or more processors in a multi-processing arrangement may also be employed to execute the sequences of instructions contained in the main memory 330. In alternative embodiments, hard-wired circuitry may be used in place or in combination with software instructions to implement the invention. Thus, embodiments of the invention are not limited to any specific combination of hardware circuitry and software.

The term “computer-readable medium” as used herein refers to any medium that participates in providing instructions to the processor 320 for execution. Such a medium may take many forms, including, but not limited to, non-volatile media, volatile media, and transmission media. Non-volatile media can include, for example, optical or magnetic disks, such as the storage device 350. Volatile media can include dynamic memory, such as the main memory 330. Transmission media can include coaxial cables, copper wire, and fiber optics, including wires that comprise the bus 310. Transmission media can also take the form of acoustic or light waves, such as those generated during radio frequency (RF) and infrared (IR) data communications. Common forms of computer-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer-readable media may be involved in carrying out one or more sequences of one or more instructions to the processor 320 for execution. For example, the instructions may initially be borne on a magnetic disk of a remote computer. The remote computer can load the instructions into its dynamic memory and send the instructions over a telephone line via, for example, a modem. A modem local to the computer system 300 can receive the data on the telephone line and use, for example, an infrared transmitter to convert the data to an infrared signal. An infrared detector can be coupled to the bus 310 and receive the data carried in the infrared signal and place the data on the bus 310. The bus 310 can carry the data to the main memory 330, from which the processor 320 can retrieve and execute the instructions. The instructions received by the main memory 330 can optionally be stored on the storage device 350 either before or after execution by the processor 320.

The computer system 300 can also include a communication interface 390 coupled to the bus 310. The communication interface 390 can provide a two-way data communication coupling to a network link 400 that is connected to a local network 410. For example, the communication interface 390 may be an integrated services digital network (ISDN) card or a modem to provide a data communication connection to a corresponding type of telephone line. As another example, the communication interface 390 may be a local area network (LAN) card to provide a data communication connection to a compatible LAN. Wireless links may also be implemented. In any such implementation, the communication interface 390 sends and receives electrical, electromagnetic, or optical signals that carry digital data streams representing various type of information.

The network link 400 typically provides data communication through one or more networks to other data devices. For example, the network link 400 may provide a connection through the local network 410 to a host computer 420 or to data equipment operated by an Internet Service Provider (ISP) 430. The ISP 430 can in turn provide data communication services through the worldwide packet data communication network, commonly referred to as the “Internet” 440. The local network 410 and Internet 440 both use electrical, electromagnetic, or optical signals that carry digital streams. The signals through the various networks and the signals on the network link 400 and through the communication interface 390, which carry the digital data to and from the computer system 300, are examples of forms of carrier waves transporting the information.

The computer system 300 can send messages and receive data, including program codes, through the network(s), network link 400, and the communication interface 390. In the Internet example, a server 450 might transmit a requested code for an application program, through the Internet 440, ISP 430, local network 410, and communication interface 390. In accordance with the embodiments discussed above, one such downloaded application provides for the simultaneous design of the PCB 10 and at least one “custom” IC package 50, as described herein.

The received code may be executed by the processor 320 as it is received and/or stored in the storage device 350, or other non-volatile storage for later execution. In this manner, the computer system 300 may obtain an application code in the form of a carrier wave.

Accordingly, the computer system 300 can be used to run software, such as modified existing CAD/EDA software or new CAD/EDA software, to simultaneously design the PCB 10 and IC package 50 using the method discussed above, whether via a stand-alone computer or via communications with a LAN or the Internet. For example, the software can include an auto-routing feature, similar to auto-routing feature of existing CAD/EDA software, to interconnect components on the PCB circuit assembly 100. However, such auto-routing feature can, in one embodiment, be selectively turned-off to allow users (e.g., circuit designers) to manually rout the interconnections between components. Additionally, the software can provide users the option to manually select components for use in the design of the PCB circuit assembly 100, such as selecting standard “off-the-shelf” ICs. Further, the software can allow users to interrupt the software operation (e.g., between design process steps) to input desired changes to the proposed design. For example, the user can interrupt the software operation to revise the placement of components or circuit routing pattern. Therefore, the software advantageously allows users to utilize their know-how during the simultaneous design of the PCB 10 and IC package 50.

The software can allow the importation of existing circuit schematic designs (e.g., via the LAN, Internet, storage device 350, etc.). In another embodiment, the software contains a library of circuit schematic designs, which can be utilized by the user to generate, for example, the initial proposed circuit design. The software can use the initial proposed circuit design as a starting point, and conduct the iterative process to arrive at the optimized design for the PCB circuit assembly 100.

The software can generate digital data files (e.g., digital codes) upon completion of the design process (e.g., in step 285), and the data files can be output to a user (e.g., a user's computer), or machine (e.g., an IC wire bonder machine). The data files, including the IC die 60 wire bond schedule, can be used to document, fabricate, test and assemble the PCB 10 and “custom” IC package 50 into the optimized PCB circuit assembly 100. In one embodiment, upon completion of the design process, the software can transmit encoded wire bonding instructions to IC wire bonder machines by any suitable means (e.g., Internet, email, LAN, other conventional methods). For example, the wire bonding instructions can be transmitted using licensed encryption technology to a desired machine for fabrication of at least one of the IC package 50 and PCB 10.

The simultaneous design of the PCB 10 and at least one “custom” IC package 50, while utilizing other components such as “standard” IC packages, resistors and capacitors, advantageously achieves an optimized PCB circuit assembly 100 design that is smaller, faster, lighter and lower in cost than conventionally designed PCB circuit assemblies. For example, in a design constructed using the methods described herein, the finished circuit is able to operate faster (based on the formula for speed of light) because the PCB 10 can be made smaller due to optimized (e.g., shorter) copper routing between components and fewer board inner layers. Because the PCB 10 is smaller in size, with fewer board inner layers, the design is also lighter. Additionally, the total manufacturing cost of the completed PCB circuit assembly 100 is advantageously reduced as well. This is because a smaller PCB 10 uses smaller amounts of process consumable materials, and fewer raw materials are used in the circuit board itself (i.e., less gold, silver, copper and petroleum based plastics). Moreover, the exterior packaging of the PCB circuit assembly 100 will require less space, advantageously resulting in smaller, lighter cabinetry and housings for the PCB circuit assembly 100. Further, because the layout of interconnections between the die 60 and the interposer substrate 58 of the IC package 50 (e.g., wire bonding schedule) is uniquely defined during the design process, the design methodology disclosed herein provides a more secure IC package design that makes reverse engineering of the “custom” IC package 50 more difficult.

All of the processes described above may be embodied in, and fully automated via, software code modules executed by one or more general purpose computers or processors. The code modules may be stored in any type of computer-readable medium or other computer storage device. Some or all of the methods may alternatively be embodied in specialized computer hardware.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. For example, steps of the method(s) disclosed herein can be performed in an order other than that disclosed in the illustrated embodiments, and additional, fewer, or different steps may be performed and still fall within the scope of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A method for designing a printed circuit board (PCB) circuit assembly by simultaneously designing interconnections for an integrated circuit (IC) package having a die chip and a printed circuit board (PCB) onto which the IC package is coupled, comprising:
accessing a routing pattern from a computer storage, said routing pattern providing the interconnection of at least two components of a desired circuit on a PCB, at least one of the components being an IC package, said routing pattern defining a preliminary circuit design;
determining if the preliminary circuit design defined by a pattern of interconnections between a die chip and an interposer substrate of the IC package and by the routing pattern between the components on the PCB meet a pre-selected set of criteria stored in a computer readable medium;
iterating between revising the pattern of interconnections between the die chip and the interposer substrate of the IC package and revising the routing pattern interconnecting components on the PCB until the set of pre-selected criteria are met to provide a final circuit design and outputting said final circuit design to a user; and
outputting digital data files corresponding to the final circuit design to a user, said digital data files usable to document, fabricate, test and assemble the PCB and the IC package.

2. The method of claim 1, wherein prior to said step of accessing a routing pattern the method further comprising:
creating a schematic of the desired circuit;
selecting at least two components for said circuit, at least one of said components being an IC package having a die chip;
defining an input/output configuration of the IC package;
laying out a pattern of interconnections between the die chip and an interposer substrate of the IC package;
defining a position of each of the components on the circuit; and
generating a routing pattern for the interconnection of the components.

3. The method of claim 1, wherein the at least two components comprise at least one component chosen from the group consisting of: a standard IC package, a resistor, a capacitor, an inductor and a memristor.

4. The method of claim, 1 wherein the interconnections between the die chip and the interposer of the IC package comprise bond wires.

5. The method of claim 4, wherein the bond wires are insulated.

6. The method of claim 2, wherein the pattern of interconnections between the die chip and the interposer substrate of the IC package is formed via flip-chip mounting.

7. The method of claim 2, wherein the pattern of interconnections between the die chip and the interposer substrate of the IC package is a ball grid array (BGA).

8. The method of claim 2, wherein the pattern of interconnections between the die chip and the interposer substrate of the IC package is formed by a stacked IC.

9. The method of claim 2, wherein generating the routing pattern for the interconnection of the components is performed with an Auto Router feature of a CAD/EDA software.

10. The method of claim 1, wherein the pre-selected set of criteria comprise at least one of electrical parameters, mechanical parameters, thermal parameters and operating speed.

11. The method of claim 1, further comprising transmitting wire bonding instructions to an IC wire bonder machine to interconnect the die chip and interposer on at least one IC package.

12. A method for designing a printed circuit board (PCB) circuit assembly by simultaneously designing an integrated circuit (IC) package having a die and a printed circuit board (PCB) onto which the IC package is coupled, comprising:
creating a schematic of the desired circuit;
selecting at least two components for said circuit, at least one of said components being an IC package having a die chip;
evaluating thermal and mechanical placement restrictions for the components;
defining the input/output configuration of the IC package;
laying out a pattern of interconnections between the die and an interposer substrate of the IC package;
defining a position of each of the components on the circuit;
generating a routing pattern to interconnect the components to define a preliminary circuit design and storing the routing pattern in a computer storage;
determining if the preliminary circuit design defined by the pattern of interconnections of the IC package and the routing pattern of the PCB meet a pre-selected set of criteria stored in a computer readable medium;
iterating between revising the pattern of interconnections between the die and the interposer substrate of the IC package and revising the routing pattern interconnecting components on the PCB until the set of pre-selected criteria are met to provide a final circuit design and outputting said final circuit design to a user;
generating digital data files corresponding to the final circuit design to document, fabricate, test and assemble the PCB and the IC package; and
outputting the digital data files to at least one of a user and an IC wire bonding machine.

13. The method of claim 12, wherein at least one of the iterating steps is performed by a computer program.

14. The method of claim 13, wherein at least one of the iterating steps includes revising at least one of the pattern of interconnections between the die chip and the interposer substrate of the IC package and revising the routing pattern interconnecting components on the PCB based at least in part on input received from a user.

15. The method of claim 12, wherein the pattern of interconnections between the die and the interposer substrate of the IC package in the final circuit design is unique to the particular final circuit design.

16. A system for designing a printed circuit board (PCB) circuit assembly by simultaneously designing an integrated circuit (IC) package having a die and a printed circuit board (PCB) onto which the IC package is coupled, comprising:
a computer storage that stores a routing pattern of interconnections between at least two components of a desired circuit on a PCB, at least one of the components being an IC package, the routing pattern defining a preliminary circuit design;
a computer readable medium that stores a pre-selected set of design criteria; and
a processor programmed to determine if the preliminary circuit design defined by the routing pattern between the components on the PCB and by a pattern of interconnections between a die chip and an interposer substrate of the IC Package meet the pre-selected set of design criteria, the processor configured to iterate between revising the pattern of interconnections between the die chip and the interposer substrate of the IC package and revising the routing pattern interconnecting components on the PCB until the set of pre-selected design criteria are met to provide a final circuit design.

17. The system of claim 16, wherein the processor generates at least one digital data file corresponding to the final circuit design and outputs said at least one digital data file to a user, the at least one digital data file usable to at least one of document, fabricate, test and assemble the PCB and the IC package.

18. The system of claim 16, wherein the computer storage stores said pattern of interconnections between the die chip and the interposer substrate of the IC package.

19. A computer-readable medium having stored thereon instructions that, when executed by a computer, cause the computer to:
access a routing pattern of interconnections between at least two components of a desired circuit on a PCB, at least one of the components being an IC package, said routing pattern defining a preliminary circuit design;
determine if the preliminary circuit design defined by a pattern of interconnections between a die chip and an interposer substrate of the IC package and by the routing pattern between the components on the PCB meet a pre-selected set of criteria;
iterate between revising the pattern of interconnections between the die chip and the interposer substrate of the IC package and revising the routing pattern interconnecting components on the PCB until the set of pre-selected criteria are met to provide a final circuit design; and
output said final circuit design to a user.

20. The computer-readable medium of claim 19, wherein the computer outputs digital data files corresponding to the final circuit design to a user, said digital data files usable to document, fabricate, test and assemble the PCB and the IC package.
